(19) United States
(12) Patent Application Publication
(10) Pub. No.: US 2025/0310881 A1
(43) Pub. Date: Oct. 2, 2025

(54) PAYLOAD AND TRANSMISSION OF LOW POWER WAKE-UP SIGNAL FOR PAGING INDICATION

(71) Applicant: QUALCOMM Incorporated, San Diego, CA (US)

(72) Inventors: Chao WEI, Beijing (CN); Ruiming ZHENG, Beijing (CN); Kangqi LIU, San Diego, CA (US); Min HUANG, Beijing (CN); Mingxi YIN, Beijing (CN); Rui HU, Beijing (CN); Hao XU, Beijing (CN)

(21) Appl. No.: 18/864,424

(22) PCT Filed: Jul. 30, 2022
(86) PCT No.: PCT/CN2022/109274

§ 371 Date: Nov. 8, 2024

(51) Int. Cl. H04W 52/02; H04L 5/00; H04W 68/00; H04W 68/02

(52) U.S. Cl. CPC H04W 52/0235; H04L 5/0044; H04W 52/0219; H04W 68/005; H04W 68/025

(57) ABSTRACT

Certain aspects of the present disclosure provide techniques for method for wireless communications by a user equipment (UE), generally including monitoring, using a first receiver, for one or more wake up signals (WUS) that map to a paging early indicator (PEI) and indicate paging subgroup information for one or more paging occasions (POs) that have a scheduled paging message and waking up a second receiver to monitor for a paging message if a WUS is detected with a payload that indicates a paging message is scheduled in a PO for a paging subgroup to which the UE belongs.

### BACKGROUND

### Field of the Disclosure

Aspects of the present disclosure relate to wireless communications, and more particularly, to techniques for paging wireless devices.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes monitoring, using a first receiver, for one or more wake up signals (WUS) that map to a paging early indicator (PEI) and indicate paging subgroup information for one or more paging occasions (POs) that have a scheduled paging message; and waking up a second receiver to monitor for a paging message if a WUS is detected with a payload that indicates a paging message is scheduled in a PO for a paging subgroup to which the UE belongs.

Another aspect provides a method of wireless communication by a network entity. The method includes transmitting a WUS that maps to a PEI and has a payload that indicates paging subgroup information for one or more POs that have a scheduled paging message; and transmitting a paging message, in at least one of the POs, as indicated in the payload of the WUS.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A and FIG. 5B depict different states of a user equipment (UE) equipped with a main radio and a low power wake up receiver (LP-WUR).

FIG. 6 depicts an example timeline and payload for a low power wake up signaling (LP-WUS).

FIG. 7A and FIG. 7B depict an example mapping and payload for paging early indication (PEI) signaling.

FIG. 8A, FIG. 8B, and FIG. 8C depict example mappings for LP-WUS to paging occasions (POs).

FIG. 9 depicts a call flow for diagram for paging indications via an LP-WUS, in accordance with aspects of the present disclosure.

FIG. 10 depicts an example payload for an LP-WUS, in accordance with aspects of the present disclosure.

FIG. 11A and FIG. 11B depict example payloads for an LP-WUS, in accordance with aspects of the present disclosure.

FIG. 12 depicts a timeline for LP-WUSs, in accordance with aspects of the present disclosure.

FIG. 13 depicts a timeline for an LP-WUS, main radio and LP-WUR activity, in accordance with aspects of the present disclosure.

FIG. 14 depicts a method for wireless communications during a monitoring occasion.

FIG. 15 depicts a method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for providing paging indications via a wake up signal (WUS).

In current wireless communications systems (e.g., 5G new radio (NR)), a user equipment (UE) may be equipped to enter into an idle or “off” mode while not actively sending or receiving wireless signals. This allows a user equipment to conserve power that would be otherwise spent monitoring for (or transmitting) signals during an active or “on” mode.

While in idle mode, a UE may begin to receive wireless communication from a serving cell. To receive the data from the serving cell, the UE exits idle mode and enters an active mode of reception. In some cases, a UE may receive a paging early indication (PEI) while in an idle state, which allows the UE to enter active mode and receive information during a paging occasion (PO). However, the UE may need to spend considerable power resources to wake up to monitor for PEIs, which may or may not indicate a paging message for the UE. Accordingly, the power saving benefit of idle mode is reduced as a result of monitoring for PEI.

Current aspects of the present disclosure provide techniques for efficiently providing paging indications to a UE via wake up signal (WUS). The techniques presented herein may help a UE conserve less power than conventional paging techniques. In some examples, a UE may be equipped with a low power wake up receiver (LP-WUR) (e.g., a wake up radio), which may monitor for low power wake up signals (LP-WUS). When an LP-WUS is detected, the LP-WUR may activate a main radio to allow the UE to enter an active state and paging messaging. By implementing aspects of the present disclosure, a UE may reduce power consumption and latency.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

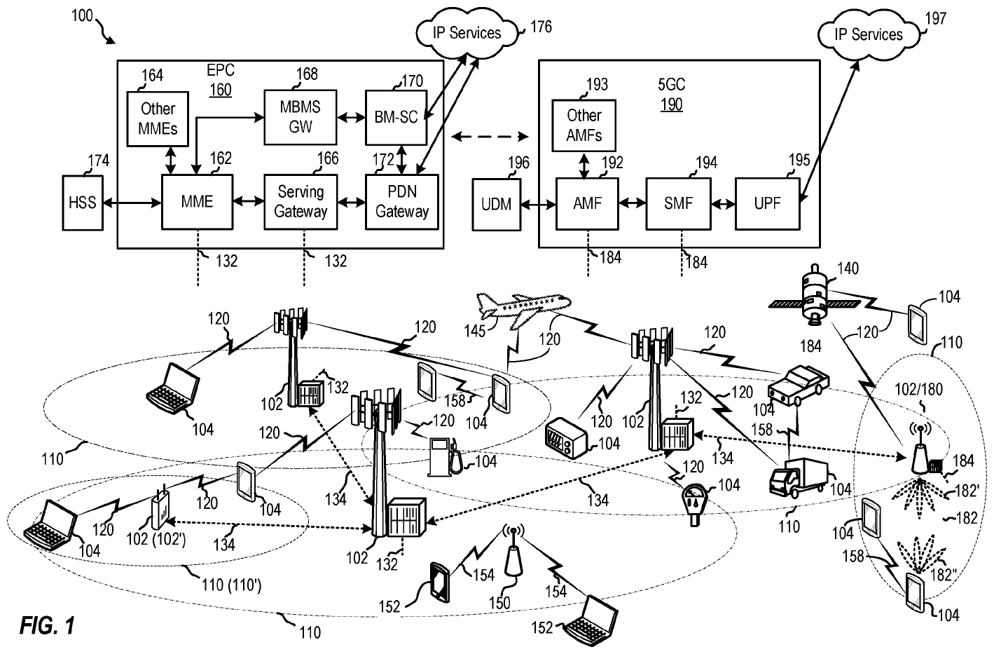

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

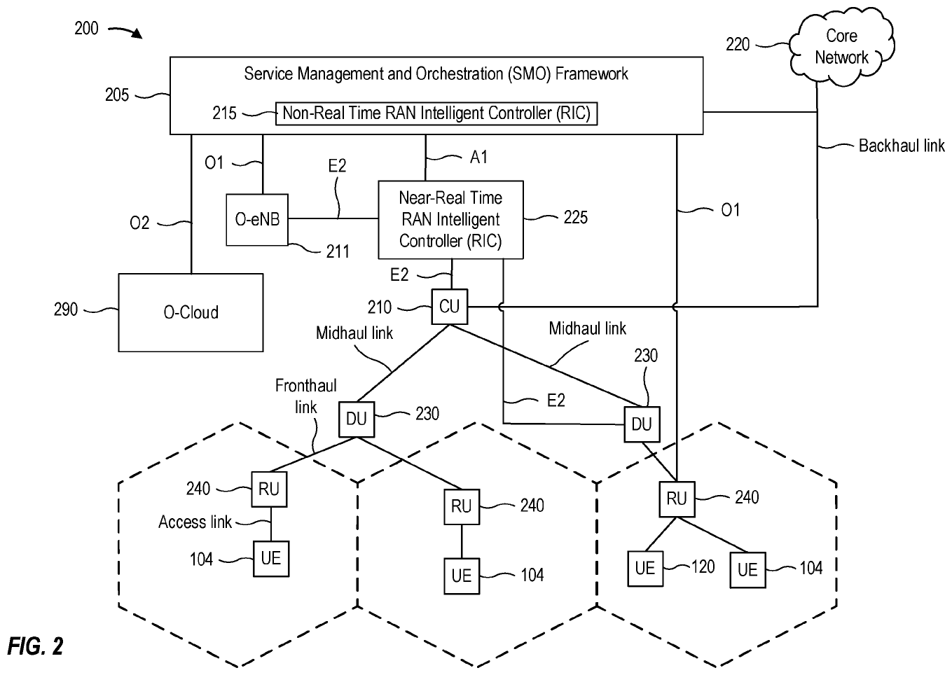

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

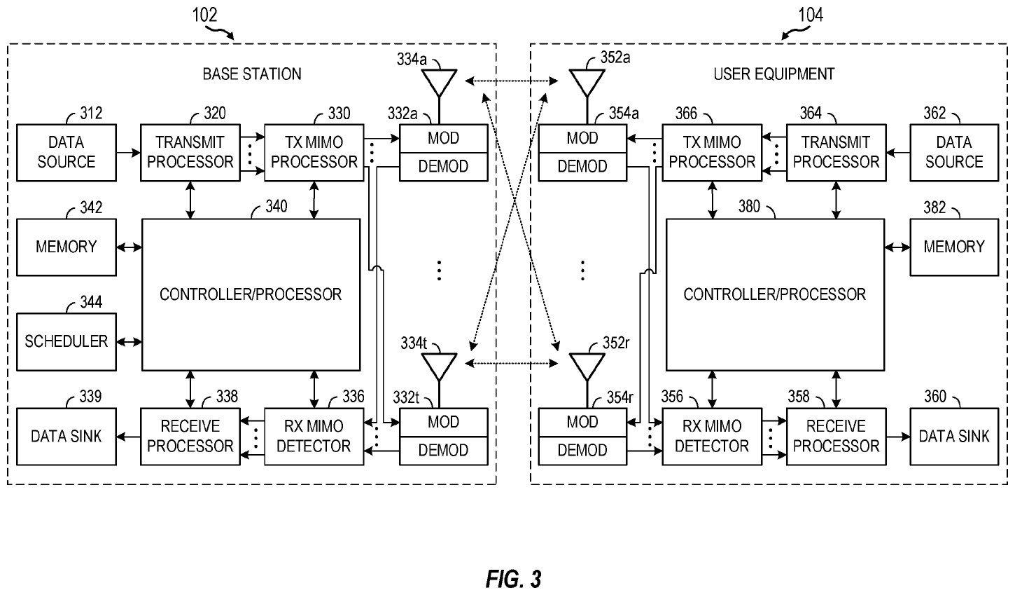

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

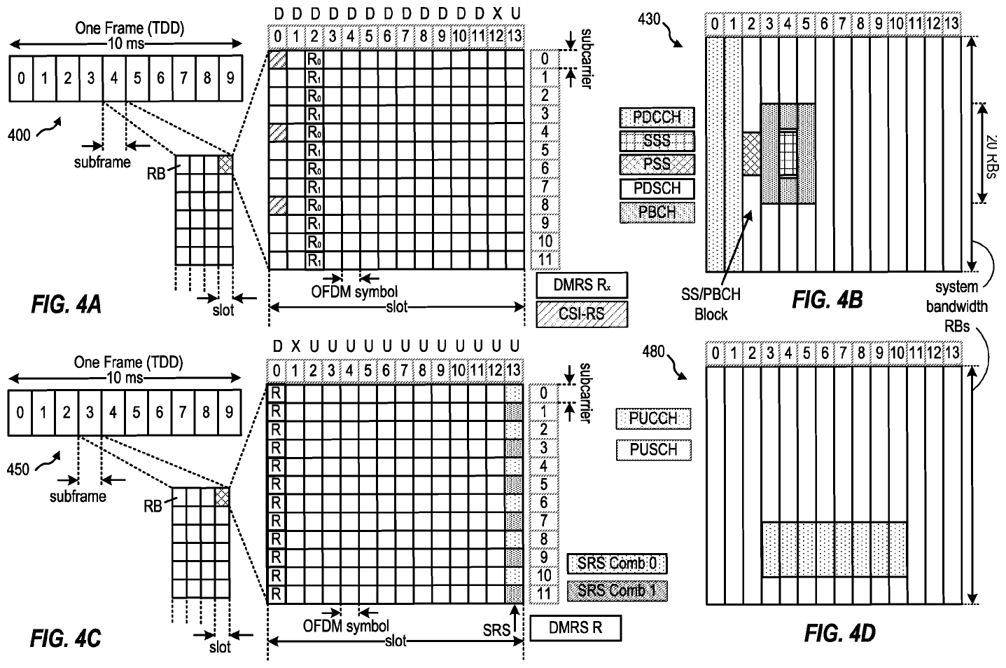

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Paging in NR

Paging configuration and monitoring for NR inherited features from the LTE paging channel design, with various elements. For example, NR uses the concept of a user equipment (UE) periodicity (T) for monitoring paging. UE derives its value for T based on a cell's default paging cycle, its own UE-specific discontinuous reception (DRX) cycle or extended DRX (eDRX) configuration. Typical values of T are 640 ms, 1280 ms, 2560 ms, and 5120 ms. Tis also referred to herein as the paging cycle.

NR also utilizes the concept of a Paging Frame (PF), which generally refers to a radio frame that contains one or more paging occasions (PO). A PO generally refers to a set of time and frequency resources during which a UE monitors for paging messages. The network typically configures a number of PFs per paging cycle, as well as a start offset for the start location of a PF within one paging cycle. Based on the configuration, a radio frame may be considered a PF if it satisfies the following equation:

$$( SFN + PF\_offset ) mod T = ( T div N ) * ( UE\_ID mod N ) ;$$

where SFN is the system frame number of the radio frame, PF_offset is the start offset for the PF, and UE_ID is the UE's ID, for example a Temporary Mobile Subscriber Identity (TMSI) assigned by a core network (CN). Within a PF, there may be one or more POs.

A PO generally refers to a set of physical downlink control channel (PDCCH) monitoring occasions where a paging indication for a UE is sent. A PO may consist of multiple time slots. Each UE may be assigned to one PO for each paging cycle. Within each PF, UEs may be randomly assigned to a PO by hashing their UE_ID, for example, according to the following equation:

$$i\_s = floor ( UE\_ID / N ) mod Ns ;$$

where i_s is the index of a PO within a PF and Ns is a number of POs within a PF. Paging messages for UEs sharing the same PO are typically multiplexed in a single physical downlink shared channel (PDSCH).

### Aspects Related to Low-Power Wake Up Signaling

In some cases, a UE may be equipped with an auxiliary receiver referred to as a low power wake-up receiver (LP-WUR) (e.g., a low power wake up radio). An LP-WUR is typically implemented using a relatively simple radio receiver circuit (e.g., non-coherent envelope detector) designed to detect low power wakeup signals (LP-WUS) with fairly low energy consumption.

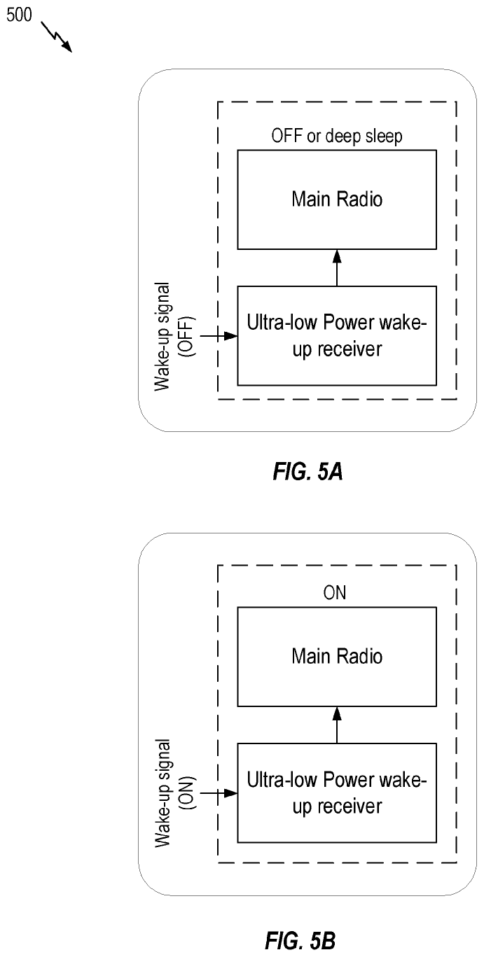

FIGS. 5A and 5B illustrates how a UE may utilize an LP-WUR to power up a main radio. When there is no data to receive, a main radio, which is coupled to an LP-WUR receiver, is set to OFF as illustrated in FIG. 5A. While in sleep mode, the LP-WUR keeps actively for monitoring low-power wakeup signal. In some cases, the LP-WUR may be operated on “always on” mode or a duty-cycle mode configured to further reduce UE power consumption. When there is data to receive, the LP-WUR receives an on-demand low power wake up signal (LP-WUS) and activates the main radio to be ON as illustrated in FIG. 5B. After activation, data is transmitted and received by the main radio.

By utilizing an LP-WUR, a user equipment (UE) may be able to conserve power with minimal impact on latency in reaching the UE via paging. A UE may enable frequent WUS monitoring to meet latency requirements. This is because a WUR typically requires significantly lower energy consumption than other conventional duty-cycling schemes where a main radio is periodically powered on for paging monitoring.

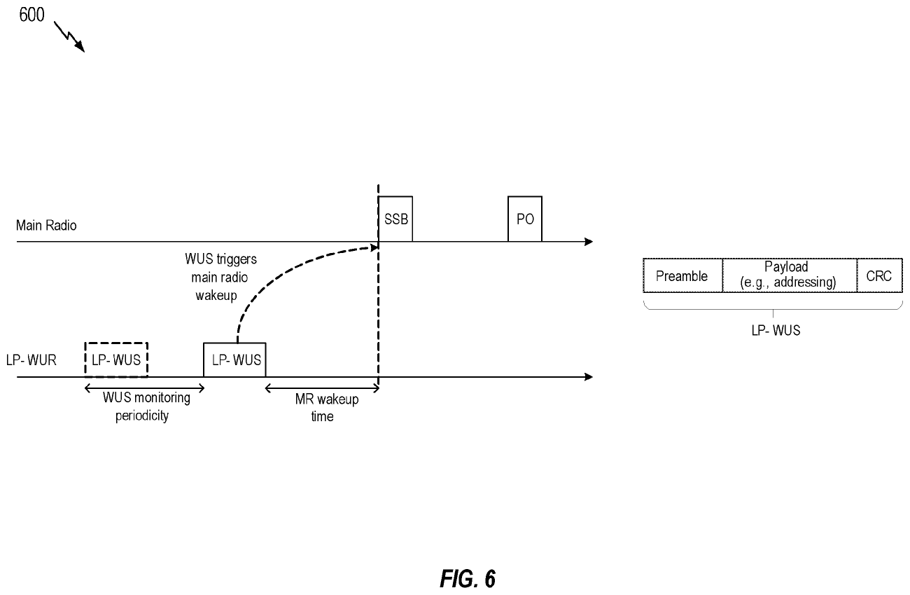

Utilization of an LP-WUS may reduce unnecessary UE paging reception. In these cases, an LP-WUS may be transmitted only if there is paging for idle or inactive mode UEs. As illustrated in FIG. 6, if an LP-WUS is detected by an LP-WUR during a WUS monitoring window, the main radio is then turned ON, and the main radio may begin monitoring synchronization signal block (SSB) to obtain timing synchronization before a paging occasion (PO). The radio may then receive paging accordingly. If an LP-WUS is not detected, the main radio stays in deep sleep mode for power saving.

FIG. 6 also illustrates an example LP-WUS. In some cases, the LP-WUS may carry more than a 1-bit payload (e.g., addressing information). Additionally, the LP-WUS contains a WUR preamble before payload and may be used for WUS detection, automatic gain control (AGC), and symbol timing recovery. Cyclic redundancy check (CRC) bits may be also appended for payload protection. In some cases, the LP-WUS can be sequence based, and a set of sequences with a maximized minimum distance are predefined each corresponding to one of the addressing information.

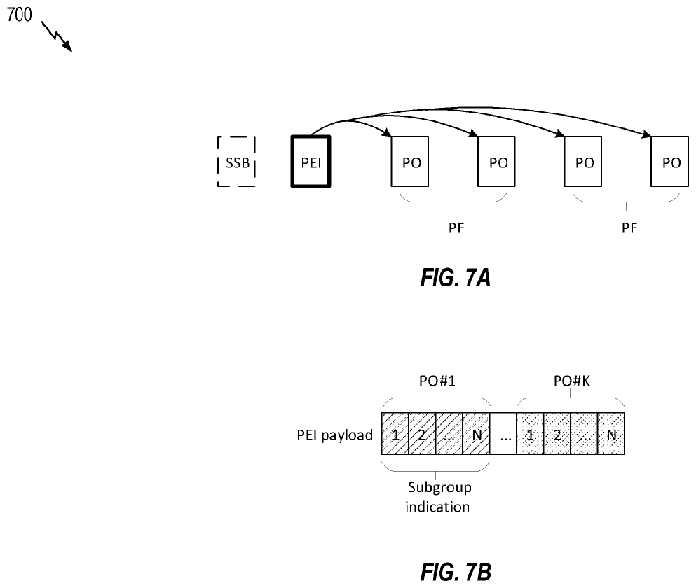

In some cases, a paging early indication (PEI) signaling mechanism may be introduced to reduce unnecessary UE paging reception. In the example illustrated in FIG. 7A, a PEI is transmitted before one or more POs at a UE and indicates whether the UE is to process upcoming POs. The PEI may indicate whether there is a paging message for a paging group (or subgroup) to which the UE belongs. A paging group or subgroup generally refers to a group of UEs that share a common PEI, for example, because they may be located in a same paging area.

As discussed above, a PEI may be considered a form of a wakeup signal, in that a UE may not process paging messaging on an upcoming PO, if a PEI is not detected. A PEI may indicate a paged UE subgroup, if UE paging subgrouping is configured. By implementing UE subgrouping, UEs associated with same PO are split into smaller subgroups, generating a paging indication that is more granular. Example subgrouping is illustrated in FIG. 7B.

A PEI can indicate one or more POs (e.g., 1, 2, 4, or 8 POs up to value N) in one or two consecutive paging frames (PFs), as shown in FIG. 7A. In some cases, a maximum number of 8 subgroups per PO may be configured by a network entity (e.g., gNB or node of a disaggregated base station). A paging indication in a PEI may be conveyed a bitmap. In such cases, each bit in the bitmap may indicate one UE group of the PO or one paging subgroup of the PO if subgrouping is configured. In certain cases, a PEI may be configured with certain downlink control information (DCI) format (e.g., DCI format 2_7).

In some cases, a UE may be configured for joint operation utilizing both LP-WUS and PEI.

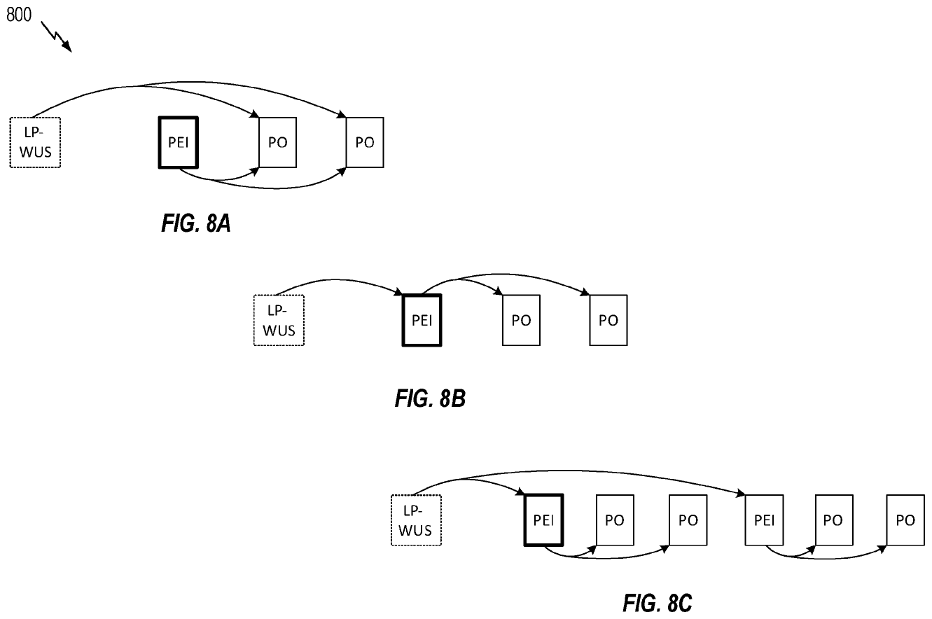

In a first example illustrated in FIG. 8A, a UE may be configured to support a same paging wakeup indication to be sent in both an LP-WUS and a PEI for all UEs. An LP-WUS may have the same PO association as the PEI and carry same paging subgroup indication as the PEI. The LP-WUR then monitors for the LP-WUS and wakes up the main radio to process paging PDCCH on the associated PO when an LP-WUS is detected. The UE may not proceed to monitor PEI if the LP-WUS is detected.

In a second example, a UE may support a two-stage wake up indication. An LP-WUS acts as a wakeup signal for PEI and indicates a wake up for one or multiple groups of PO. A PEI indicates a wake up for the paging subgroup of the PO. One example of a two stage wake up indication is illustrated in FIG. 8B, where a one-to-one mapping between a PEI and an LP-WUS occurs (e.g., the same PO assignment occurs for PEI and LP-WUS). Another example of a two stage wake up indication is illustrated in FIG. 8C, where one LP-WUS is associated with multiple PEIs (e.g., different PO assignments occur for PEI and LP-WUS). Different from the first example, the UE may to proceed to monitor PEI if the LP-WUS is detected in the second example.

The first example, due to the same paging wakeup indication being sent in both an LP-WUS and a PEI for all UEs, large overhead may be required for transmitting paging subgroup indication. For example, indicating 8 POs, each with 8 paging subgroups may require a total of 64 bits to transmit (i.e., 8 POs*8 subgroups=64 bits). In the current state of the art, an LP-WUS may not be able to support a large payload due to its low physical (PHY) bitrate. In some cases, (e.g., for an 802.11ba) a WUS physical layer (PHY) may support only two data rates. For example, the first data rate may be 62.5 kbps with 4 μs symbol duration and the other may be 250 kbps with 2 μs symbol duration, and the high data rate is only for UEs with high signal-to-noise (SNR). Assuming a 100 kbps data rate for NR LP-WUS, a duration of 0.8 ms is needed to transmit a 64 bits payload and a 16 bits CRC. If a WUR preamble is considered, the WUS duration may be larger than 1 ms (1 subframe SF duration).

The second example may require less payload than the first example, but the UE power saving consumption is reduced as a result of unnecessary main radio wakeup signaling for PEI monitoring. Additionally, the gap between an LP-WUS and a PO may be significantly larger in the second example as a result of additional PEI reception, and the large gap may potentially increase the paging latency if paging comes after the reception of the LP-WUS but before the reception of the PEI.

Further, the misdetection rate of an LP-WUS can be much higher than a PEI PDCCH due to the relatively simple and less robust nature of an LP-WUR. As a result, a UE may miss paging in various cases if the main radio is activated based on receiving a positive indication in an LP-WUS. In one case, a UE detects LP-WUS but the CRC check fails. In another case, a UE does not detect a valid LP-WUS (e.g., no WUR preamble is detected).

The paging indication techniques proposed herein may help avoid the large payload size of the first example, while still maintaining relatively low paging latency.

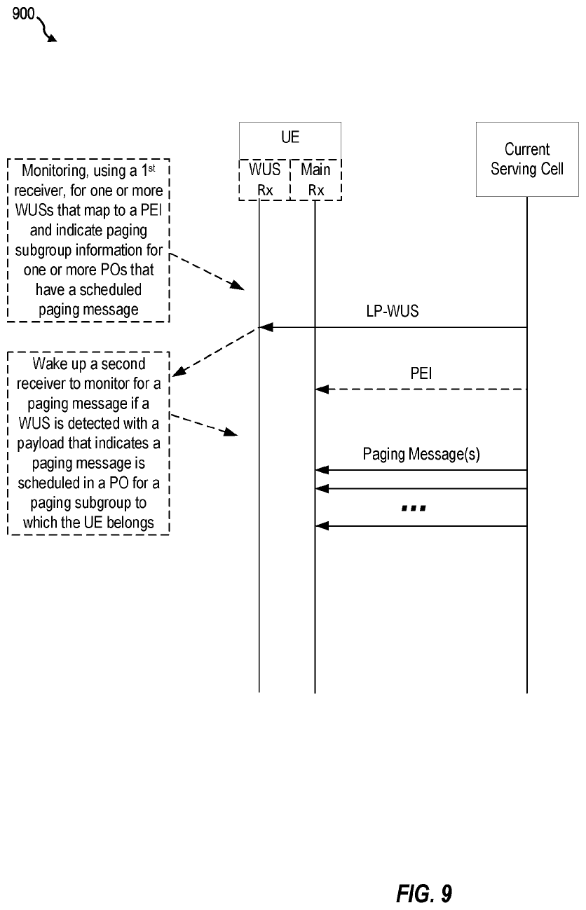

The paging indication mechanisms proposed herein may be understood with reference to the call flow diagram 900 of FIG. 9.

The call flow diagram 900 shows example signaling between a network entity and a UE. In some aspects, the network entity may be an example of the BS 102 depicted and described with respect to FIGS. 1 and 3 or a disaggregated base station depicted and described with respect to FIG. 2. Similarly, the UE may be an example of UE 104 depicted and described with respect to FIGS. 1 and 3. However, in other aspects, UE 104 may be another type of wireless communications device and BS 102 may be another type of network entity or network node, such as those described herein.

As illustrated, a UE may monitor, using a first receiver (e.g., an LP-WUR), for one or more WUSs that map to a PEI and indicate paging subgroup information for one or more POs that have a scheduled paging message. During the monitoring, the current serving cell transmits an LP-WUS.

In response to receiving the LP-WUS at the first receiver, the UE may wake up a second receiver (e.g., a main radio) to monitor for a paging message if a WUS is detected with a payload that indicates that a paging message is scheduled in a PO for a paging subgroup to which the UE belongs. Optionally, the current serving cell may transmit a PEI to ensure that the main radio of UE is ready to receive paging messages during a paging occasion. Then, the main radio of the UE receives one or more paging messages during a paging occasion.

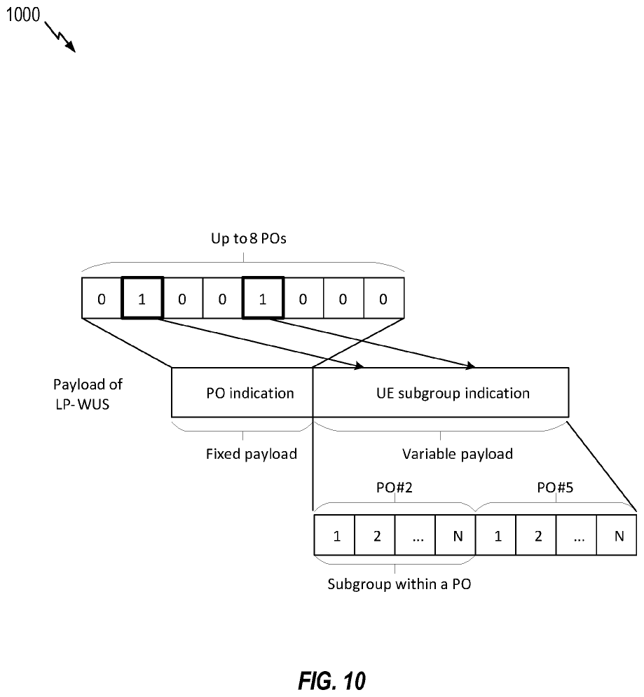

According to certain aspects, a UE may monitor for paging only if it detects an indication only for a PO (for its subgroup) with a positive paging indication. Example positive paging indications are illustrated in FIG. 10.

In the illustrated example, an LP-WUS payload contains 8 paging indications, two of which are positive “1” indications. The LP-WUS payload consists of a first part indicating whether there is paging on the associated PO, and a second part of a paging subgroup indication that may be optionally included. The size of the payload may be based on the number of positive paging indications in the first part (in this example, there are two positive paging indications).

In some cases, an LP-WUR may know the size of the second part by decoding the first part. As illustrated in FIG. 10, the first part may contain a PO indication, and the second part may contain a UE subgroup indication. The first part may be a fixed payload, and the second part may be a variable payload. The variable payload may comprise one or more PO occasions having subgroups.

According to certain aspects, a UE may enhance an LP-WUS by addressing many or all POs that have positive paging indication via payload segmentation and mapping to multiple LP-WUSs.

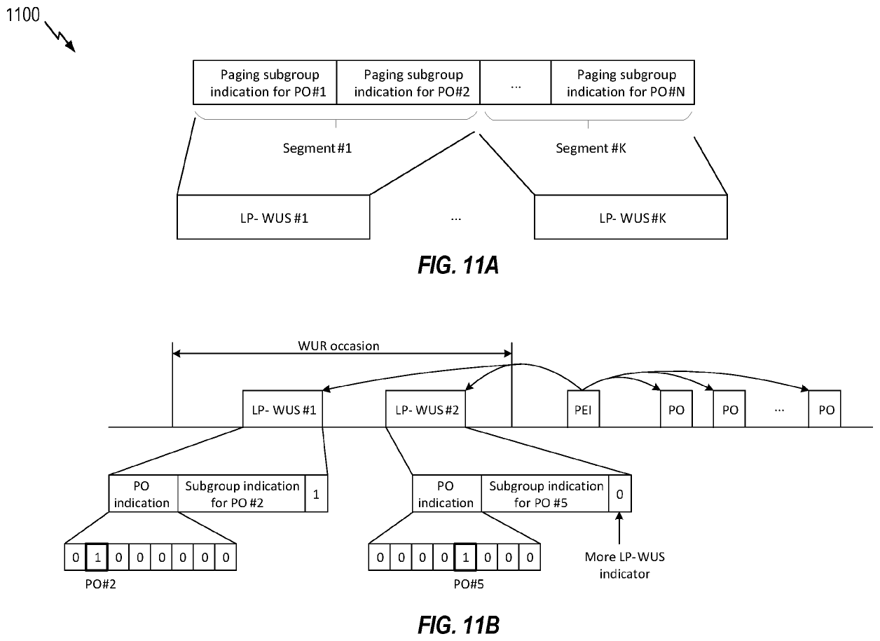

In one example case illustrated in FIG. 11A, a UE may implement semi-static segmentation where one PEI is mapped to a fixed number of time division multiplexed (TDM'd) or frequency division multiplexed (FDM'd) LP-WUS. The mapping may be predefined, and the UE may monitor only one LP-WUS. A first LP-WUS (e.g., LP-WUS #1) corresponds to segment #1, while subsequent LP-WUS transmissions (e.g., LP-WUS #K) correspond to segments #K.

In another case, the UE may support dynamic segmentation where one PEI is mapped to a variable number of TDM'd LP-WUS, as illustrated in FIG. 11B.

In such cases, the mapping is dynamic and each transmitted LP-WUS consists of two parts: a PO indication and an optional subgroup indication, where each PO indication in each LP-WUS may be different from one another. The PO indication may contain at least one positive paging indication.

In some cases, a UE may be required to monitor all LP-WUS(s) to receive the paging subgroup indication. As an alternative, a 1-bit early termination LP-WUS indication can be included in an LP-WUS to indicate whether to continue monitoring a subsequent LP-WUS when one LP-WUS is detected in the set of WUR monitoring occasions associated with the PO. Applying a 1-bit LP-WUS indication may reduce overhead. In some examples, the 1-bit LP-WUS early termination indication may be implicitly encoded to the LP-WUS by, for example, transmitting a bitwise complement of the preamble sequence or using a mask to scramble the CRC bits.

An example of such a 1-bit LP-WUS indication is illustrated in FIG. 11B. Both complete (all LP-WUS) monitoring and 1-bit indication scenarios assume multiple LP-WUS are transmitted in the same set of WUR monitoring occasions associated with the PO(s).

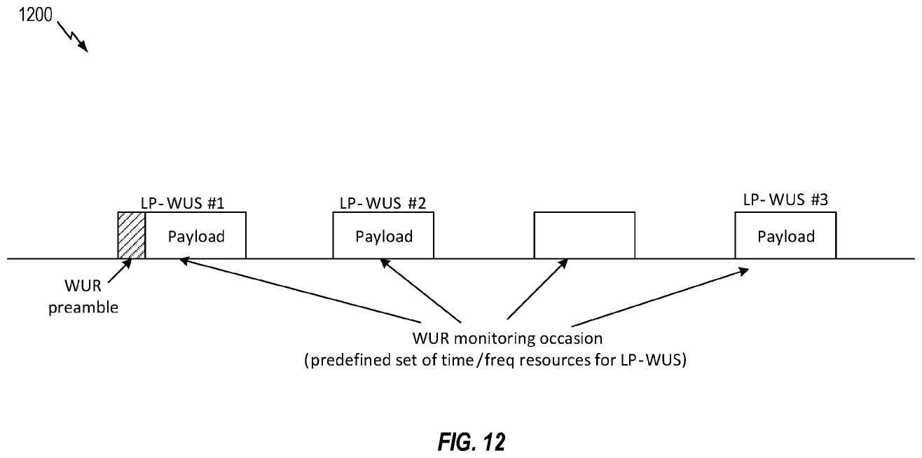

Various signaling options are possible, for example, to optimize latency or signaling overhead. For example, in certain cases (e.g., TDM'd multiple LP-WUS), only the first LP-WUS may include a WUR preamble and the subsequent LP-WUS may carry only a payload (e.g., paging indication) without preamble. As illustrated in FIG. 12, a WUR preamble may be used on the first LP-WUS for automatic gain control (AGC), determination of the start of an LP-WUS, and symbol timing recovery. The WUR preamble in the first LP-WUS may be used also for receiving subsequent LP-WUS that are quasi co-located with the first LP-WUS.

According to certain aspects, to mitigate the misdetection of an LP-WUS at the UE, a set of criteria can be defined to assist the UE decision for main radio wakeup for PEI monitoring or paging PDCCH reception. If UE does not detect any LP-WUS (e.g., when a CRC error is detected or no LP-WUS preamble is detected) since a last paging time window (PTW), UE wakes up the MR before the start of the next PTW for monitoring PEI or legacy paging.

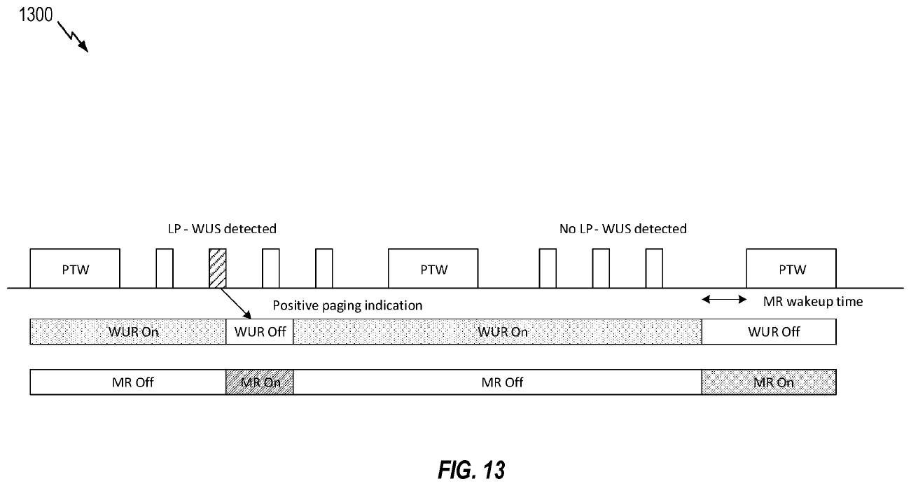

As illustrated in FIG. 13, if an LP-WUS is detected with a CRC pass, the UE may not turn on the main radio in the upcoming PTW. Other options such as based on WUR radio link quality measurement can also be considered. A network may not be required to transmit LP-WUS when there is no paging indication (i.e., DTX is allowed for LP-WUS).

### Example Operations of a User Equipment

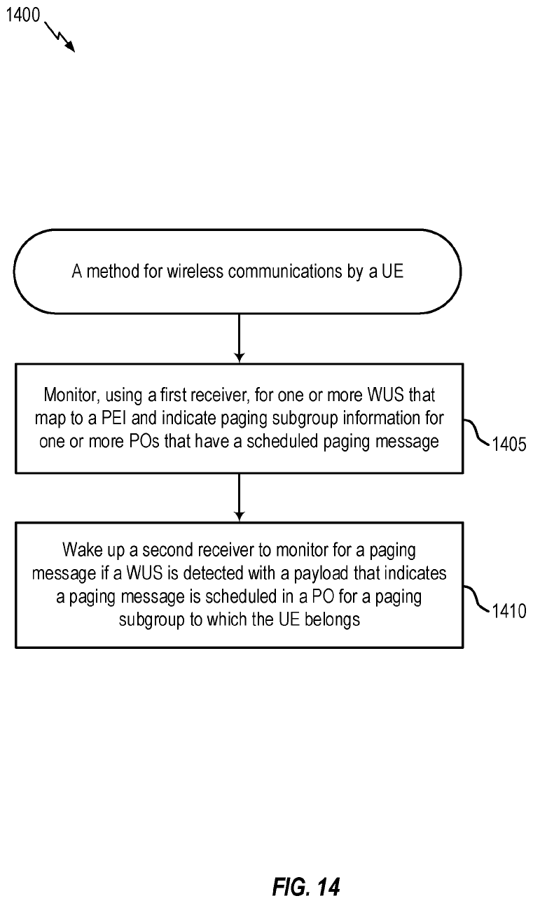

FIG. 14 shows an example of a method 1400 for wireless communications by a UE, such as UE 104 of FIGS. 1 and 3.

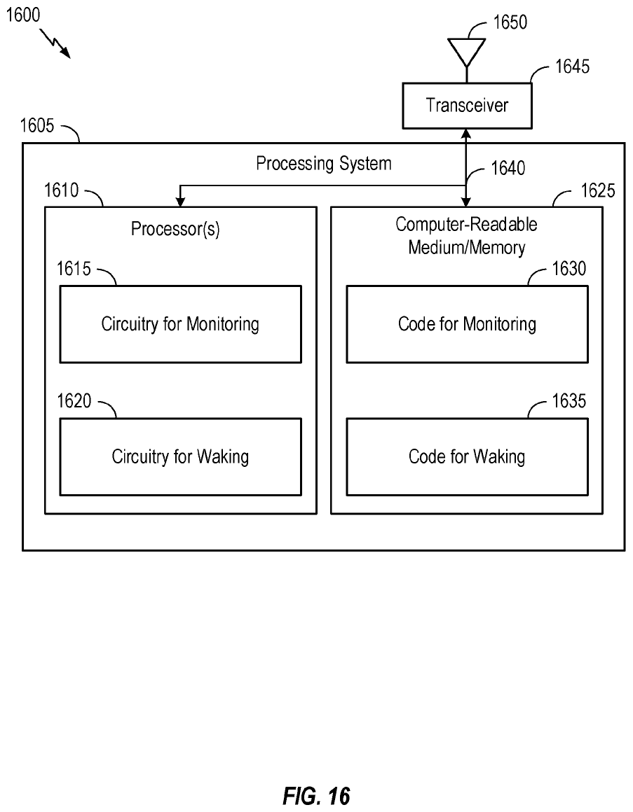

Method 1400 begins at step 1405 with monitoring, using a first receiver, for one or more WUS that map to a PEI and indicate paging subgroup information for one or more POs that have a scheduled paging message. In some cases, the operations of this step refer to, or may be performed by, circuitry for monitoring and/or code for monitoring as described with reference to FIG. 16.

Method 1400 then proceeds to step 1410 with waking up a second receiver to monitor for a paging message if a WUS is detected with a payload that indicates a paging message is scheduled in a PO for a paging subgroup to which the UE belongs. In some cases, the operations of this step refer to, or may be performed by, circuitry for waking and/or code for waking as described with reference to FIG. 16.

In some aspects, a first portion of the payload indicates one or more POs that have a scheduled paging message a second portion of the payload indicates paging subgroup information for the one or more POs that have a scheduled paging message.

In some aspects, the first portion of the payload has a fixed size; and the second portion of the payload has a variable size that depends on how many POs have a scheduled paging message, as indicated by the first portion of the payload.

In some aspects, a third portion of the payload indicates whether the UE should monitor for a subsequent WUS.

In some aspects, the payload comprises: one or more portions, each portion indicating paging subgroup information for a different PO, wherein each portion is transmitted within one of the multiple WUSs.

In some aspects, multiple WUSs are time multiplexed within a WUS monitoring occasion associated with a PEI.

In some aspects, a number of WUS candidates the UE is expected to monitor within a WUS monitoring occasion is limited by a capability of the UE.

In some aspects, a first of the multiple WUSs has a preamble and payload; and remaining of the multiple WUSs have a payload and lack a preamble.

In some aspects, the method 1400 further includes waking up the second receiver to monitor for the PEI if one or more criteria are met. In some cases, the operations of this step refer to, or may be performed by, circuitry for waking and/or code for waking as described with reference to FIG. 16.

In some aspects, the criteria comprise the UE failing to detect a WUS since a previous PTW; and the UE wakes up the second receiver to monitor for the PEI in a subsequent PTW if the criteria is met.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Operations of a Network Entity

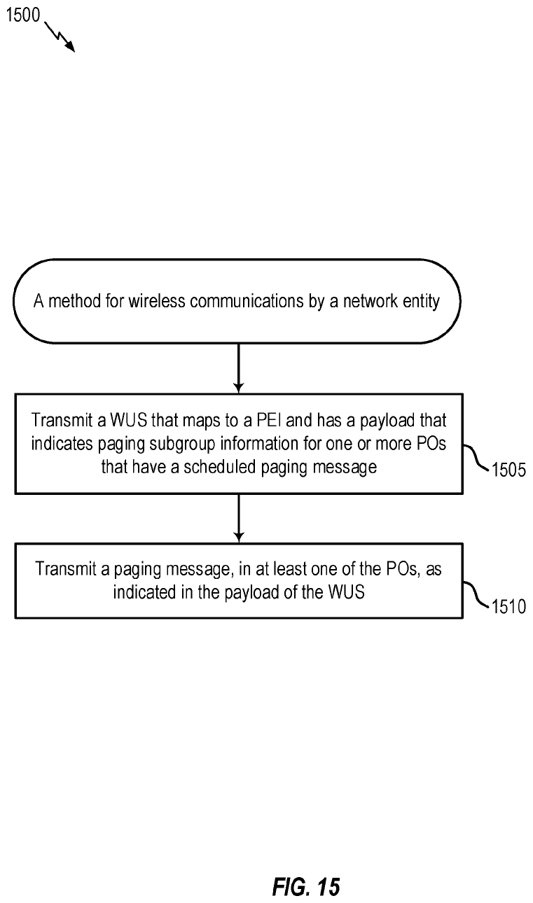

FIG. 15 shows an example of a method 1500 for wireless communications by a network entity, such as BS 102 of FIGS. 1 and 3, or a disaggregated base station as discussed with respect to FIG. 2.

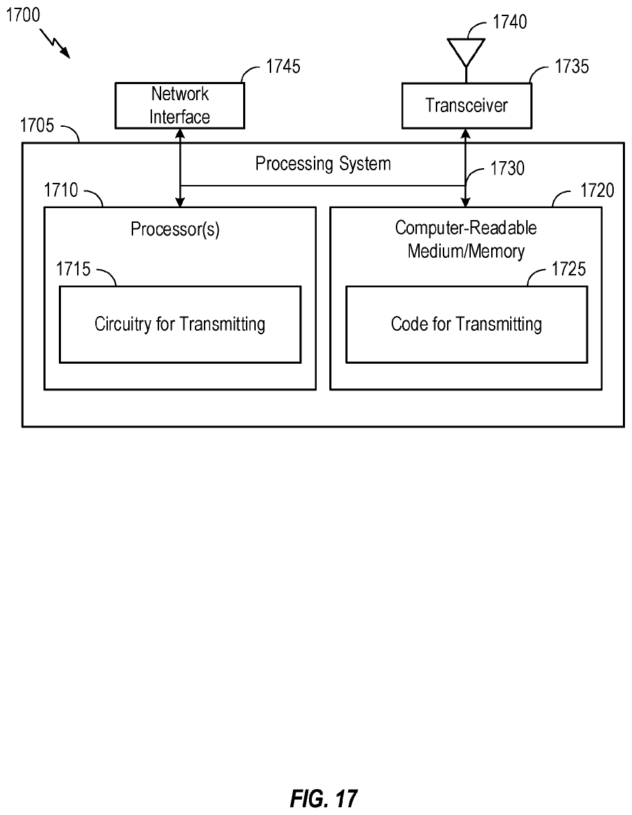

Method 1500 begins at step 1505 with transmitting a WUS that maps to a PEI and has a payload that indicates paging subgroup information for one or more POs that have a scheduled paging message. In some cases, the operations of this step refer to, or may be performed by, circuitry for transmitting and/or code for transmitting as described with reference to FIG. 17.

Method 1500 then proceeds to step 1510 with transmitting a paging message, in at least one of the POs, as indicated in the payload of the WUS. In some cases, the operations of this step refer to, or may be performed by, circuitry for transmitting and/or code for transmitting as described with reference to FIG. 17.

In some aspects, a first portion of the payload indicates one or more POs that have a scheduled paging message; and a second portion of the payload indicates paging subgroup information for the one or more POs that have a scheduled paging message.

In some aspects, the first portion of the payload has a fixed size; and the second portion of the payload has a variable size that depends on how many POs have a scheduled paging message, as indicated by the first portion of the payload.

In some aspects, a third portion of the payload indicates whether the UE should monitor for a subsequent WUS.

In some aspects, the payload comprises: one or more portions, each portion indicating paging subgroup information for a different PO, wherein each portion is transmitted within one of the multiple WUSs.

In some aspects, multiple WUSs are time multiplexed within a WUS monitoring occasion associated with a PEI.

In some aspects, a first of the multiple WUSs has a preamble and payload; and remaining of the multiple WUSs have a payload and lack a preamble.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

### Example Communications Devices

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to the transceiver 1645 (e.g., a transmitter and/or a receiver). The transceiver 1645 is configured to transmit and receive signals for the communications device 1600 via the antenna 1650, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1625 via a bus 1640. In certain aspects, the computer-readable medium/memory 1625 is configured to store instructions (e.g., computer-executable code) that when executed by the one or more processors 1610, cause the one or more processors 1610 to perform the method 1400 described with respect to FIG. 14, or any aspect related to it. Note that reference to a processor performing a function of communications device 1600 may include one or more processors 1610 performing that function of communications device 1600.

In the depicted example, computer-readable medium/memory 1625 stores code (e.g., executable instructions), such as code for monitoring 1630 and code for waking 1635. Processing of the code for monitoring 1630 and code for waking 1635 may cause the communications device 1600 to perform the method 1400 described with respect to FIG. 14, or any aspect related to it.

The one or more processors 1610 include circuitry configured to implement (e.g., execute) the code stored in the computer-readable medium/memory 1625, including circuitry such as circuitry for monitoring 1615 and circuitry for waking 1620. Processing with circuitry for monitoring 1615 and circuitry for waking 1620 may cause the communications device 1600 to perform the method 1400 described with respect to FIG. 14, or any aspect related to it.

Various components of the communications device 1600 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3 and/or the transceiver 1645 and the antenna 1650 of the communications device 1600 in FIG. 16. Means for receiving or obtaining may include transceivers 354 and/or antenna(s) 352 of the UE 104 illustrated in FIG. 3 and/or the transceiver 1645 and the antenna 1650 of the communications device 1600 in FIG. 16.

FIG. 17 depicts aspects of an example communications device 1700. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1735 (e.g., a transmitter and/or a receiver) and/or a network interface 1745. The transceiver 1735 is configured to transmit and receive signals for the communications device 1700 via the antenna 1740, such as the various signals as described herein. The network interface 1745 is configured to obtain and send signals for the communications device 1700 via communication link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1720 via a bus 1730. In certain aspects, the computer-readable medium/memory 1720 is configured to store instructions (e.g., computer-executable code) that when executed by the one or more processors 1710, cause the one or more processors 1710 to perform the method 1500 described with respect to FIG. 15, or any aspect related to it. Note that reference to a processor of communications device 1700 performing a function may include one or more processors 1710 of communications device 1700 performing that function.

In the depicted example, the computer-readable medium/memory 1720 stores code (e.g., executable instructions), such as code for transmitting 1725. Processing of the code for transmitting 1725 may cause the communications device 1700 to perform the method 1500 described with respect to FIG. 15, or any aspect related to it.

The one or more processors 1710 include circuitry configured to implement (e.g., execute) the code stored in the computer-readable medium/memory 1720, including circuitry such as circuitry for transmitting 1715. Processing with circuitry for transmitting 1715 may cause the communications device 1700 to perform the method 1500 as described with respect to FIG. 15, or any aspect related to it.

Various components of the communications device 1700 may provide means for performing the method 1500 as described with respect to FIG. 15, or any aspect related to it. Means for transmitting, sending or outputting for transmission may include transceivers 332 and/or antenna(s) 334 of the BS 102 illustrated in FIG. 3 and/or the transceiver 1735 and the antenna 1740 of the communications device 1700 in FIG. 17. Means for receiving or obtaining may include transceivers 332 and/or antenna(s) 334 of the BS 102 illustrated in FIG. 3 and/or the transceiver 1735 and the antenna 1740 of the communications device 1700 in FIG. 17.

### Example Clauses

Implementation examples are described in the following numbered clauses:

Clause 1: A method for wireless communications by a UE, comprising: monitoring, using a first receiver, for one or more WUS that map to a PEI and indicate paging subgroup information for one or more POs that have a scheduled paging message; and waking up a second receiver to monitor for a paging message if a WUS is detected with a payload that indicates a paging message is scheduled in a PO for a paging subgroup to which the UE belongs.

Clause 2: The method of Clause 1, wherein: a first portion of the payload indicates one or more POs that have a scheduled paging message a second portion of the payload indicates paging subgroup information for the one or more POs that have a scheduled paging message.

Clause 3: The method of Clause 2, wherein: the first portion of the payload has a fixed size; and the second portion of the payload has a variable size that depends on how many POs have a scheduled paging message, as indicated by the first portion of the payload.

Clause 4: The method of Clause 2, wherein: a third portion of the payload indicates whether the UE should monitor for a subsequent WUS.

Clause 5: The method of any one of Clauses 1-4, wherein the payload comprises: one or more portions, each portion indicating paging subgroup information for a different PO, wherein each portion is transmitted within one of the multiple WUSs.

Clause 6: The method of any one of Clauses 1-5, wherein multiple WUSs are time multiplexed within a WUS monitoring occasion associated with a PEI.

Clause 7: The method of Clause 6, wherein a number of WUS candidates the UE is expected to monitor within a WUS monitoring occasion is limited by a capability of the UE.

Clause 8: The method of Clause 6, wherein: a first of the multiple WUSs has a preamble and payload; and remaining of the multiple WUSs have a payload and lack a preamble.

Clause 9: The method of any one of Clauses 1-8, further comprising: waking up the second receiver to monitor for the PEI if one or more criteria are met.

Clause 10: The method of Clause 9, wherein: the criteria comprise the UE failing to detect a WUS since a previous PTW; and the UE wakes up the second receiver to monitor for the PEI in a subsequent PTW if the criteria is met.

Clause 11: A method for wireless communications by a network entity, comprising: transmitting a WUS that maps to a PEI and has a payload that indicates paging subgroup information for one or more POs that have a scheduled paging message; and transmitting a paging message, in at least one of the POs, as indicated in the payload of the WUS.

Clause 12: The method of Clause 11, wherein: a first portion of the payload indicates one or more POs that have a scheduled paging message; and a second portion of the payload indicates paging subgroup information for the one or more POs that have a scheduled paging message.

Clause 13: The method of Clause 12, wherein: the first portion of the payload has a fixed size; and the second portion of the payload has a variable size that depends on how many POs have a scheduled paging message, as indicated by the first portion of the payload.

Clause 14: The method of Clause 12, wherein: a third portion of the payload indicates whether the UE should monitor for a subsequent WUS.

Clause 15: The method of any one of Clauses 11-14, wherein the payload comprises: one or more portions, each portion indicating paging subgroup information for a different PO, wherein each portion is transmitted within one of the multiple WUSs.

Clause 16: The method of any one of Clauses 11-15, wherein multiple WUSs are time multiplexed within a WUS monitoring occasion associated with a PEI.

Clause 17: The method of Clause 16, wherein: a first of the multiple WUSs has a preamble and payload; and remaining of the multiple WUSs have a payload and lack a preamble.

Clause 18: An apparatus, comprising: a memory comprising executable instructions; and a processor configured to execute the executable instructions and cause the apparatus to perform a method in accordance with any one of Clauses 1-17.

Clause 19: An apparatus, comprising means for performing a method in accordance with any one of Clauses 1-17.

Clause 20: A non-transitory computer-readable medium comprising executable instructions that, when executed by a processor of an apparatus, cause the apparatus to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications by a user equipment (UE), comprising:
a memory comprising executable instructions; and
one or more processors configured to execute the executable instructions and cause the reader device to:
monitor, using a first receiver, for one or more wake up signals (WUS) that map to a paging early indicator (PEI) and indicate paging subgroup information for one or more paging occasions (POs) that have a scheduled paging message; and
wake up a second receiver to monitor for a paging message if a WUS is detected with a payload that indicates a paging message is scheduled in a PO for a paging subgroup to which the UE belongs.

2. The apparatus of claim 1, wherein:
a first portion of the payload indicates one or more POs that have a scheduled paging message; and
a second portion of the payload indicates paging subgroup information for the one or more POs that have a scheduled paging message.

3. The apparatus of claim 2, wherein:
the first portion of the payload has a fixed size; and
the second portion of the payload has a variable size that depends on how many POs have a scheduled paging message, as indicated by the first portion of the payload.

4. The apparatus of claim 2, wherein:
a third portion of the payload indicates whether the UE should monitor for a subsequent WUS.

5. The apparatus of claim 1, wherein the payload comprises:
one or more portions, each portion indicating paging subgroup information for a different PO, wherein each portion is transmitted within multiple WUSs.

6. The apparatus of claim 1, wherein multiple WUSs are time multiplexed within a WUS monitoring occasion associated with a paging early indicator (PEI).

7. The apparatus of claim 6, wherein a number of WUS candidates the UE is expected to monitor within a WUS monitoring occasion is limited by a capability of the UE.

8. The apparatus of claim 6, wherein:
a first of the multiple WUSs has a preamble and payload; and
remaining of the multiple WUSs have a payload and lack a preamble.

9. The apparatus of claim 1, wherein the one or more processors configured to execute the executable instructions and cause the reader device to:
wake up the second receiver to monitor for the PEI if one or more criteria are met.

10. The apparatus of claim 9, wherein:
the criteria comprise the UE failing to detect a WUS since a previous paging time window (PTW); and
the UE wakes up the second receiver to monitor for the PEI in a subsequent PTW if the criteria is met.

11. An apparatus for wireless communications by a network entity, comprising:
a memory comprising executable instructions; and
one or more processors configured to execute the executable instructions and cause the reader device to:
transmit a wake up signal (WUS) that maps to a paging early indicator (PEI) and has a payload that indicates paging subgroup information for one or more paging occasions (POs) that have a scheduled paging message; and
transmit a paging message, in at least one of the POs, as indicated in the payload of the WUS.

12. The apparatus of claim 11, wherein:
a first portion of the payload indicates one or more POs that have a scheduled paging message; and
a second portion of the payload indicates paging subgroup information for the one or more POs that have a scheduled paging message.

13. The apparatus of claim 12, wherein:
the first portion of the payload has a fixed size; and
the second portion of the payload has a variable size that depends on how many POs have a scheduled paging message, as indicated by the first portion of the payload.

14. The apparatus of claim 12, wherein:
a third portion of the payload indicates whether the UE should monitor for a subsequent WUS.

15. The apparatus of claim 11, wherein the payload comprises:
one or more portions, each portion indicating paging subgroup information for a different PO, wherein each portion is transmitted within multiple WUSs.

16. The apparatus of claim 11, wherein multiple WUSs are time multiplexed within a WUS monitoring occasion associated with a paging early indicator (PEI).

17. The apparatus of claim 16, wherein:
a first of the multiple WUSs has a preamble and payload; and
remaining of the multiple WUSs have a payload and lack a preamble.

18. A method for wireless communications by a user equipment (UE), comprising:
monitoring, using a first receiver, for one or more wake up signals (WUS) that map to a paging early indicator (PEI) and indicate paging subgroup information for one or more paging occasions (POs) that have a scheduled paging message; and
waking up a second receiver to monitor for a paging message if a WUS is detected with a payload that indicates a paging message is scheduled in a PO for a paging subgroup to which the UE belongs.

19. The method of claim 18, wherein:
a first portion of the payload indicates one or more POs that have a scheduled paging message; and
a second portion of the payload indicates paging subgroup information for the one or more POs that have a scheduled paging message.

20. The method of claim 19, wherein:
the first portion of the payload has a fixed size; and
the second portion of the payload has a variable size that depends on how many POs have a scheduled paging message, as indicated by the first portion of the payload.

21. The method of claim 19, wherein:
a third portion of the payload indicates whether the UE should monitor for a subsequent WUS.

22. The method of claim 18, wherein the payload comprises:
one or more portions, each portion indicating paging subgroup information for a different PO, wherein each portion is transmitted within multiple WUSs.

23. The method of claim 18, wherein multiple WUSs are time multiplexed within a WUS monitoring occasion associated with a paging early indicator (PEI).

24. The method of claim 23, wherein a number of WUS candidates the UE is expected to monitor within a WUS monitoring occasion is limited by a capability of the UE.

25. The method of claim 23, wherein:
a first of the multiple WUSs has a preamble and payload; and
remaining of the multiple WUSs have a payload and lack a preamble.

26. The method of claim 18, wherein the one or more processors configured to execute the executable instructions and cause the reader device to:
wake up the second receiver to monitor for the PEI if one or more criteria are met.

27. The method of claim 26, wherein:
the criteria comprise the UE failing to detect a WUS since a previous paging time window (PTW); and
the UE wakes up the second receiver to monitor for the PEI in a subsequent PTW if the criteria is met.

28. A method for wireless communications by a network entity, comprising:
transmitting a wake up signal (WUS) that maps to a paging early indicator (PEI) and has a payload that indicates paging subgroup information for one or more paging occasions (POs) that have a scheduled paging message; and
transmitting a paging message, in at least one of the POs, as indicated in the payload of the WUS.

29. The method of claim 28, wherein:
a first portion of the payload indicates one or more POs that have a scheduled paging message; and
a second portion of the payload indicates paging subgroup information for the one or more POs that have a scheduled paging message.

30. The method of claim 29, wherein:
the first portion of the payload has a fixed size; and
the second portion of the payload has a variable size that depends on how many POs have a scheduled paging message, as indicated by the first portion of the payload.
